(19) United States
(12) Patent Application Publication
(10) Pub. No.: US 2011/0265957 A1
(43) Pub. Date: Nov. 3, 2011

(54) ROMAN SHADE STRUCTURE

(75) Inventor: Chung-Yuh Tsai, Taipei City (TW)

(73) Assignee: JOY YOU INDUSTRIAL CORORATION

(21) Appl. No.: 12/770,855

(22) Filed: Apr. 30, 2010

(51) Int. Cl. E06B 9/24

(52) U.S. Cl. 160/84.04

(57) ABSTRACT

A roman shade structure includes a shade face having a cord disposed thereon; when the cord is pulled down, the shade face moves upward to act as a curtain. The shade face comprises a protection layer disposed at a back side thereof; the protection layer covers a surface having the cord on the shade face to keep the cord from exposing to the outside. A through hole for each cord is disposed on the upper end of the protection layer for allowing the cord to work properly. Moreover, a cover is disposed on an upper end of the shade face; the cover hides the exposed cords and the cordlock to enhance safety and the esthetics of the improved roman shade structure.

### BACKGROUND OF THE INVENTION

1. Field of the Invention

The present invention relates to a curtain, and more particularly, to an improved roman shade structure using a cover to protect the user from being strangled by cords accidentally and to enhance safety in using the roman shades.

2. Description of the Prior Art

Roman shades are pull-up type curtains made of fabrics. Compared with roll-up type curtains, the roman shades have their shades stacked to provide simple and durable structure. Furthermore, compared with a traditional window curtain which is opened by pulling laterally, the roman shades can create spacious feel; therefore they are widely adopted in various applications. Moreover, the roman shades are stacked in layers to create gradient looks; therefore they can be used to enhance the design esthetics for windows.

FIG. 5 illustrates a perspective view of a traditional roman shade structure. The traditional roman shade structure comprises a shade face 1a and a cord 2a, the cord 2a has it bottom end fixed at the lower end of the shade face 1a and an upper end gathered at the upper end of the shade face 1a to be pulled down by the user so as to lift the shade face 1a upward.

However, the traditional roman shade structure might cause danger as its cord 2a is exposed to the outside of the shade face 1a. In some extreme cases, the cord 2a directly accessible to the user could strangle the user, in particular, children.

Therefore, the prior-art technique presents some shortcomings to be overcome. In view of the deficiencies of the prior-art technique, after constant effort, the inventor has consequently invented and disclosed the improved roman shade structure in the present invention.

### SUMMARY OF THE INVENTION

The objective of the present invention is to disclose an improved roman shade structure, which hides the exposed cords of the traditional roman shades to enhance safety of the improved roman shade structure.

In order to achieve this objective, an improved roman shade structure is disclosed. The improved roman shade structure comprises a shade face having a cord disposed thereon to act as a curtain. The shade face comprises a protection layer disposed at a back side thereof; the protection layer covers a surface having the cord on the shade face to keep the cord from exposing to the outside and to prevent the user from being strangled by the cords. A through hole for each cord is disposed on the upper end of the protection layer for allowing the cord to work properly. Moreover, a cover is disposed on an upper end of the shade face; the cover completely hides the exposed cords and the cordlock to enhance safety and the esthetics of the improved roman shade structure.

### BRIEF DESCRIPTION OF THE DRAWINGS

The drawings disclose an illustrative embodiment of the present invention which serves to exemplify the various advantages and objects hereof, and are as follows:

FIG. 1 illustrates a perspective view of an improved roman shade structure in the present invention;

FIG. 2 illustrates a planar view of the improved roman shade structure;

FIG. 3 illustrates a perspective operational view of the improved roman shade structure;

FIG. 4 illustrates a planar view of the improved roman shade structure; and

FIG. 5 illustrates a perspective view of a traditional roman shade structure.

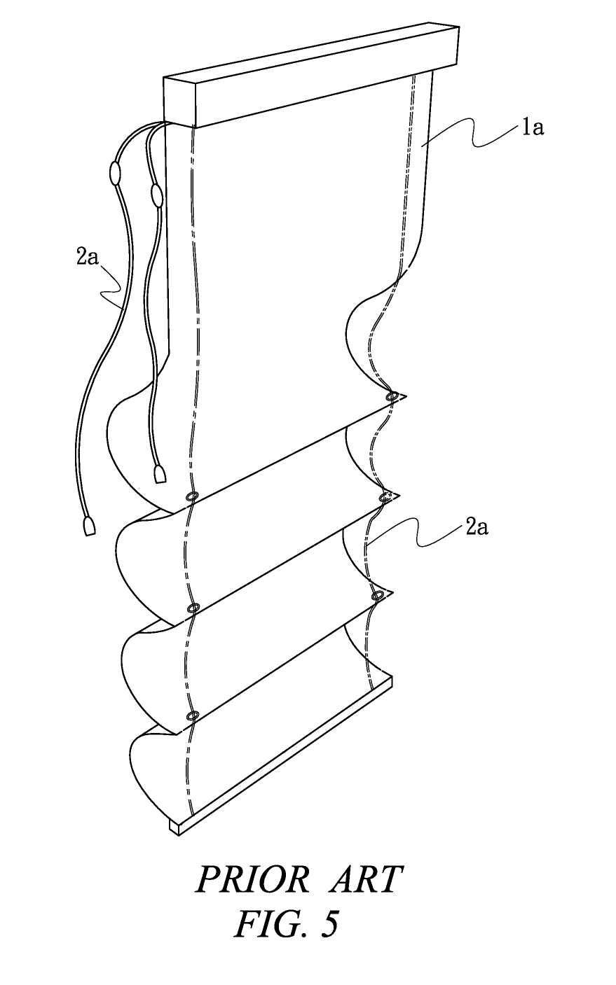

### DETAILED DESCRIPTION OF THE PREFERRED EMBODIMENT

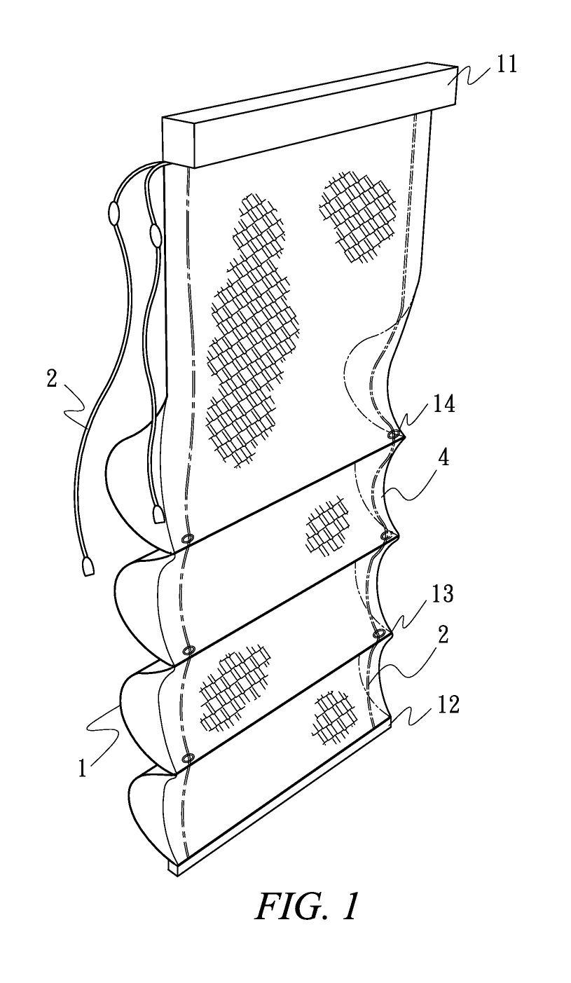

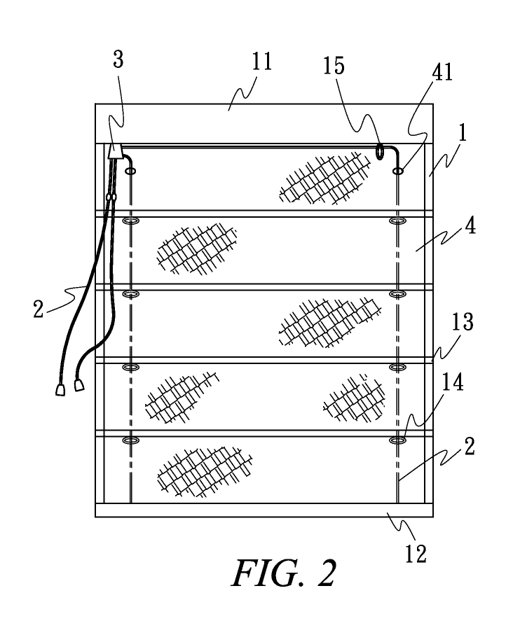

Please refer to FIG. 1 and FIG. 2 for an improved roman shade structure in the present invention, which mainly comprises a shade face 1, the shade face 1 is usually made of fabrics, the shade face 1 has a solid header 11 disposed on an upper end thereof and a dowel 12 disposed at an lower end of the shade face 1 for keeping the shape of the shade face 1. A plurality of cords 2 is disposed at the back side of the shade face 1. A cordlock 3 is disposed on a side on top of the shade face; therefore, the cords 2 have their bottom ends fixed to the lower end of the shade face 1 and their top ends gather at the cordlock 3 to be pulled down. The shade face 1 is disposed with a plurality stacking layer 13 in equal distance, each stacking layer 13 is disposed with a number of eyelets 14 corresponding to the number of the cords 2 so as to let the cords 2 pass through the eyelets 14 and remain stretched. Furthermore, except the cord 2 directly connected to the cordlock 3, other cords 2 respectively connect to the cordlock 3 via rings 15 on the header 11 corresponding the cords 2; therefore each cord is gathered to the position of the cordlock 3.

By using the above structure, when the user pulls down the cords 2, the bottom ends of the cords 2 lift the shade face 1 upward to form a gradient look visually due to the stacking layers 13.

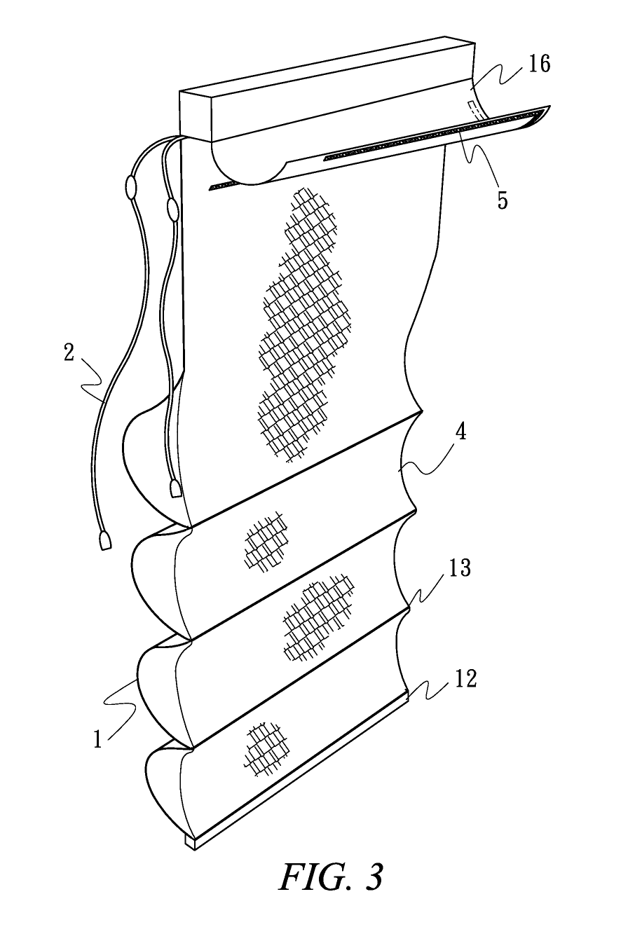

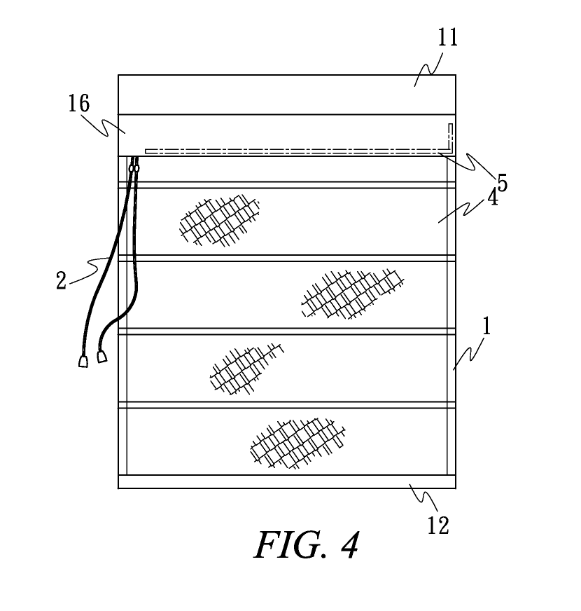

The novel feature of the present invention lies in that the protection layer 4 is disposed at the back side of the shade face 1, the protection layer 4 covers the surface having the cords 2 disposed thereon, the protection layer 4 is made of gauze, cotton, polyester, or the like and is sewed to the shade face, thereby keeping the cords 2 from exposing to the outside and preventing the user from being strangled by the cords. A through hole 41 is disposed on the upper end of the protection layer 4 for allowing the cords to pass through the through hole 41 and work properly. As shown in FIG. 3 and FIG. 4, a cover is disposed on the upper end of the shade face 1; the cover 16 covers the header 11 and the protection layer 4 to hide the exposed cords 2 on the shade face 1, the cordlock 3, and other related components to enhance safety and the esthetics of the improved roman shade structure. The cover 16, the shade face 1 and the protection layer 4 are bonded with each other by a combining layer 5, the combining layer 5 uses a VELCRO® or other fastening means to affix the cover 16, to the protection layer 4.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A roman shade structure comprising a shade face disposed with a plurality of cords, the shade face having a cordlock disposed on a side on top of the shade face for gathering the plurality of cords to be pulled down, wherein the roman shade structure includes a protection layer covering a surface having the plurality of cords on the shade face to keep the plurality of cords from exposing to the outside.

2. The roman shade structure as claimed in claim 1, wherein the protection layer comprises a through hole disposed on an upper end thereof for allowing the cord to pass through.

3. The roman shade structure as claimed in claim 1, wherein the protection layer is made of gauze, cotton, polyester, or the like and is sewed to the shade face.

4. A roman shade structure comprising a shade face disposed with a plurality of cords, the shade face having a cordlock disposed on a side on top of the shade face for gathering the plurality of cords to be pulled down, wherein the roman shade structure includes:
a protection layer covering a surface having the plurality of cords on the shade face to keep the plurality of cords from exposing to the outside; and
a cover disposed on an upper end of the shade face, the cover hiding the exposed cords or the cordlock.

5. The roman shade structure as claimed in claim 4, wherein the protection layer comprises a through hole disposed on an upper end thereof for allowing the cord to pass through.

6. The roman shade structure as claimed in claim 4, wherein the protection layer is made of gauze, cotton, polyester, or the like and is sewed to the shade face.

7. The roman shade structure as claimed in claim 4, wherein the cover, and the protection layer are bonded with each other by a combining layer, the combining layer uses a VELCRO® or other fastening means to affix the cover, to the protection layer.
